(19) United States
(12) Patent Application Publication
(10) Pub. No.: US 2011/0126243 A1
(43) Pub. Date: May 26, 2011

(54) Device, method and system for transmitting data network based data over a wireless video link

(76) Inventor: Shay Freundlich, Givat Ada (IL)

(21) Appl. No.: 12/591,530

(22) Filed: Nov. 23, 2009

(51) Int. Cl. H04N 7/18

(52) U.S. Cl. 725/81; 725/109; 455/3.05

(57) ABSTRACT

Disclosed is a method, circuit and system for transmitting data network based data (e.g. TCP/IP, UDP/IP) over a wireless video link. There is provided circuitry adapted to receive network data traffic and to insert the received data traffic into a transmission signal (e.g. downlink video and/or control signals, and/or uplink control signals) generated by a wireless video signal transceiver.

### FIELD OF THE INVENTION

Some embodiments relate generally to the field of wireless communication and, more particularly, to a device, method and system for transmitting data network based data over a wireless video link.

### BACKGROUND

Wireless communication has rapidly evolved over the past decades. Even today, when high performance and high bandwidth wireless communication equipment is made available there is demand for even higher performance at a higher data rates, which may be required by more demanding applications.

Video signals may be generated by various video sources, for example, a computer, a game console, a Video Cassette Recorder (VCR), a Digital-Versatile-Disc (DVD), a Blu-ray (BR) disk player, or any other suitable video source. In many houses, for example, video signals are received through cable or satellite links at a Set-Top Box (STB) located at a fixed point.

In many cases, it may be desired to place a screen or projector at a location in a distance of at least a few meters from the video source. This trend is becoming more common as flat-screen displays, e.g., plasma or Liquid Crystal Display (LCD) televisions are hung on a wall. Connection of such a display or projector to the video source through cables is generally undesired for aesthetic reasons and/or installation convenience. Thus, wireless transmission of the video signals from the video source to the screen is preferred.

WHDI—Wireless Home Digital Interface is a new standard for wireless high-definition video connectivity between a video source (e.g. cable box) and video sink (e.g. display). It provides a high-quality, uncompressed wireless link which can support delivery of equivalent video data rates of up to 3 Gbit/s (including uncompressed 1080p) in a 40 MHz channel within the 5 GHz unlicensed band. Equivalent video data rates of up to 1.5 Gbit/s (including uncompressed 1080i and 720p) can be delivered on a single 20 MHz channel in the 5 GHz unlicensed band, conforming to worldwide 5 GHz spectrum regulations. Range is beyond 100 feet (30 m), through walls, and latency is less than one millisecond.

### SUMMARY OF THE INVENTION

The present invention is a method, circuit and system for transmitting data network based data (e.g. TCP/IP, UDP/IP) over a wireless video link. According to some embodiments of the present invention, there may be provided a wireless video signal transceiver which may be a video source transceiver or a video sink transceiver. The transceiver may include a port/connector (e.g. Ethernet port) or other input-line(s) for receiving data networking data (e.g. IP packets) from one or more network data source(s) such as a network client application or a network server application. According to some embodiments of the present invention, the data packet network port/connector/input-line may be functionally associated with network device emulation circuitry adapted to emulate a network switch, router, bridge, access point, WHDI access point or any other network device or appliance capable of TCP/IP, UDP/IP or other data networking standard compliant communication. The emulation circuitry may be adapted to receive network data traffic (e.g. IP packets) and to forward the received data traffic to a functionally associated insertion circuit, which circuit may be adapted to insert data received through the data packet network port/connector/input-line into a transmission signal (e.g. downlink video and/or control signals, and/or uplink control signals) generated by a wireless video signal transceiver. According to further embodiments of the present invention, either the emulation circuitry or the insertion circuit may include or otherwise be functionally associated with a data buffer adapted to buffer data received via the port/connector/input-line or otherwise. According to further embodiments of the present invention, network data traffic may be inserted into a downlink video signal transmitted by a video source transceiver—during and/or in between bursts of wireless video transmission. According to yet further embodiments of the present invention, network data traffic may be inserted into an uplink signal transmitted by a video sink transceiver—during and/or in between bursts of wireless video transmission.

According to some embodiments of the present invention, there may be provided a wireless video signal transceiver which may be a video source transceiver or a video sink transceiver. The transceiver may include a port/connector (e.g. Ethernet port) or other output-line(s) for transmitting network data (e.g. IP packets) to one or more network data sink(s) such as a network client application or a network server application. According to some embodiments of the present invention, the data packet network port/connector/output-line may be functionally associated with network device emulation circuitry adapted to emulate a network switch, router, bridge, access point, WHDI access point or any other network device or appliance capable of TCP/IP, UDP/IP or other data networking standard compliant communication. The emulation circuitry may be adapted to transmit network data traffic (e.g. IP packets) received from a functionally associated extraction circuit, which extraction circuit may be adapted to extract data from a received signal (e.g. downlink video and/or control signals, and/or uplink control signals) generated by another wireless video signal transceiver. According to further embodiments of the present invention, either the emulation circuitry or the extraction circuit may include or otherwise be functionally associated with a data buffer adapted to buffer data.

According to some embodiments of the present invention, the port/connector/output-line and the port/connector/input-line may be functionally associated, integral with one another and/or the same port/connector/line. Likewise, the network device emulation circuitry associated with a port/connector/output-line and with a port/connector/input-line may be the same circuit.

According to some embodiments of the present invention, network data may be inserted into a video signal, generated by a video source transceiver, during one or more blanking intervals (e.g. vertical blanking interval or horizontal blanking intervals) of a frame of the video signal. According to some embodiments of the present invention, network data may be inserted into a video signal within a signal segment of the signal allocated for transmission of a video block or frame having less data than the data bearing capacity of the allocated slot (e.g. a blank or static video block/frame). According to some embodiments of the present invention, network data may be inserted into a signal segment of the signal allocated for control data having less data than the data bearing capacity of the allocated slot.

According to some embodiments of the present invention, network data may be inserted into an uplink signal generated by a video sink transceiver. The video sink transceiver may insert the network data into an uplink signal while it is not receiving a video signal. The video sink transceiver may also insert the network data into an uplink signal generated during one or more blanking intervals (e.g. vertical blanking interval or horizontal blanking intervals) of a frame of a video signal the sink transceiver is receiving.

According to some embodiments of the present invention, a video source transceiver or a video sink transceiver may be functionally associated with a data extraction circuit to extract network data packet from a received video related signal (i.e. downstream video or downstream/upstream control signaling). According to further embodiments of the present invention, network data may be recombined and/or reconstructed into an original sequence, data structure or format (e.g. packetized) from the extracted data. Optionally, the reconstructed data may be buffered. Reconstructed data may be provided to a functionally associated neemulation circuitry adapted to emulate a packet network switch, router, bridge or any other network device or appliance. The emulation circuit may transmit the data out of a data packet network port/connector/output-line(s) in compliance with data network protocols.

According to some embodiments of the present invention, a wireless video stream transceiver source may transmit and receive signals along one or more channels (i.e. signals modulated at one or more carrier frequencies) within a specified frequency range (i.e. bandwidth). The allotted bandwidth may be substantially dedicated to transmitting downlink video and/or control signals thus providing sufficient bandwidth for the functionally associated insertion circuit to insert data received via the data packet network port/connector/input-line into the transmission signal. According to further embodiments of the present invention, the wireless video stream transceiver source may have negligible bandwidth dedicated to receiving signals from a video sink transceiver via its uplink. According to further embodiments of the present invention, network data transmitted from a video sink transceiver may be received while the video source transceiver is not transmitting a video signal. The network data may also be received during one or more blanking intervals (e.g. vertical blanking interval or horizontal blanking intervals) of a frame of the video signal transmitted by the video source transceiver.

According to some embodiments of the present invention, a wireless video stream transceiver sink may transmit and receive signals along one or more channels (i.e. signals modulated at one or more carrier frequencies) within a specified frequency range (i.e. bandwidth). The allotted bandwidth may be substantially dedicated to receiving downlink video thus providing sufficient bandwidth for receiving network data within the video stream. According to further embodiments of the present invention, the wireless video stream transceiver sink may have negligible bandwidth dedicated for uplink transmission to a video source transceiver. According to further embodiments of the present invention, network data may be transmitted to a video source transceiver while the video sink transceiver is not receiving a video signal from the video source transceiver. The network data may also be transmitted during one or more blanking intervals (e.g. vertical blanking interval or horizontal blanking intervals) of a frame of the video signal.

According to some embodiments of the present invention, wireless video stream transceiver control logic may give priority to video data over network data. According to further embodiments of the present invention, multiplexing network data with the video data may not cause a loss of quality of service (e.g. video quality or latency).

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 shows an exemplary video transceiver and data network arrangement, according to some embodiments of the present invention;

FIG. 2A is a functional block diagram of an exemplary data transmitter/receiver pair according to some embodiments of the present invention where the transmitter includes an insertion circuit and the receiver includes an extraction circuit;

FIG. 2B is a functional block diagram of an exemplary data transmitter/receiver pair according to some embodiments of the present invention where the receiver includes an insertion circuit and the transmitter includes an extraction circuit;

FIG. 3A is a flow chart including the steps of a method by which a data transmitter/receiver pair may insert network data into a video data stream and extract network from a video data stream in accordance with the exemplary embodiment of FIG. 2A;

FIG. 3B is a flow chart including the steps of a method by which a data transmitter/receiver pair may extract network from a video data stream and insert network data into a video data stream in accordance with the exemplary embodiment of FIG. 2B;

FIG. 4A is a schematic diagram of video frames in which each frame has a video data portion, a horizontal blanking interval (HBI) portion and a vertical blanking interval (VBI) portion (prior art);

FIG. 4B is a schematic diagram showing a video frame according to some embodiments of the present invention;

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices. In addition, the term “plurality” may be used throughout the specification to describe two or more components, devices, elements, parameters and the like.

It should be understood that some embodiments may be used in a variety of applications. Although embodiments of the invention are not limited in this respect, one or more of the methods, devices and/or systems disclosed herein may be used in many applications, e.g., civil applications, military applications, medical applications, commercial applications, or any other suitable application. In some demonstrative embodiments the methods, devices and/or systems disclosed herein may be used in the field of consumer electronics, for example, as part of any suitable television, video Accessories, Digital-Versatile-Disc (DVD), multimedia projectors, Audio and/or Video (A/V) receivers/transmitters, gaming consoles, video cameras, video recorders, portable media players, cell phones, mobile devices, and/or automobile A/V accessories. In some demonstrative embodiments the methods, devices and/or systems disclosed herein may be used in the field of Personal Computers (PC), for example, as part of any suitable desktop PC, notebook PC, monitor, and/or PC accessories. In some demonstrative embodiments the methods, devices and/or systems disclosed herein may be used in the field of professional A/V, for example, as part of any suitable camera, video camera, and/or A/V accessories. In some demonstrative embodiments the methods, devices and/or systems disclosed herein may be used in the medical field, for example, as part of any suitable endoscopy device and/or system, medical video monitor, and/or medical accessories. In some demonstrative embodiments the methods, devices and/or systems disclosed herein may be used in the field of security and/or surveillance, for example, as part of any suitable security camera, and/or surveillance equipment. In some demonstrative embodiments the methods, devices and/or systems disclosed herein may be used in the fields of military, defense, digital signage, commercial displays, retail accessories, and/or any other suitable field or application.

Although embodiments of the invention are not limited in this respect, one or more of the methods, devices and/or systems disclosed herein may be used to wirelessly transmit video signals, for example, High-Definition-Television (HDTV) signals, between at least one video source and at least one video destination. In other embodiments, the methods, devices and/or systems disclosed herein may be used to transmit, in addition to or instead of the video signals, any other suitable signals, for example, any suitable multimedia signals, e.g., audio signals, between any suitable multimedia source and/or destination.

Although some demonstrative embodiments are described herein with relation to wireless communication including video information, some embodiments may be implemented to perform wireless communication of any other suitable information, for example, multimedia information, e.g., audio information, in addition to or instead of the video information. Some embodiments may include, for example, a method, device and/or system of performing wireless communication of A/V information, e.g., including audio and/or video information. Accordingly, one or more of the devices, systems and/or methods described herein with relation to video information may be adapted to perform wireless communication of A/V information.

Some demonstrative embodiments may be implemented to communicate wireless-video signals over a wireless-video communication link, as well as Wireless-Local-Area-Network (WLAN) signals over a WLAN link. Such implementation may allow a user, for example, to play a movie, e.g., on a laptop computer, and to wirelessly transmit video signals corresponding to the movie to a video destination, e.g., a screen, while maintaining a WLAN connection, e.g., with the Internet and/or one or more other devices connected to a WLAN network. In one example, video information corresponding to the movie may be received over the WLAN network, e.g., from the Internet.

According to some embodiments of the present invention there is provided a wireless video source transceiver comprising a wireless downlink transmitter circuit, a wireless uplink receiver circuit and a network data insertion circuit. According to further embodiments of the present invention, the wireless downlink transmitter circuit may be adapted to transmit a video based data signal. According to further embodiments of the present invention, the wireless uplink receiver circuit may be adapted to receive a control signal. According to further embodiments of the present invention, the network data insertion circuit may be adapted to receive network based data and to insert the data into a transmission of the wireless downlink transmitter circuit.

According to some embodiments of the present invention, the network data insertion circuit may be further adapted to receive network data from a functionally associated network device emulation circuit. According to further embodiments of the present invention, the network device emulation circuit may be further adapted to receive network data. According to further embodiments of the present invention, the network device emulation circuit may be further adapted to receive network data from a functionally associated data packet network port/input-line. According to further embodiments of the present invention, the data packet network port/input-line may be further adapted to receive network data from a functionally associated network data source. According to further embodiments of the present invention, the data packet network port/input-line may be further adapted to be a wireless port.

According to some embodiments of the present invention, the wireless uplink receiver may be further adapted to receive network data from a functionally associated wireless video sink transceiver. According to some embodiments of the present invention, the transceiver may be further adapted to receive network data from a functionally associated data network and transmit network data to another functionally associated data network.

According to some embodiments of the present invention there is provided a wireless video sink transceiver comprising a wireless downlink receiver circuit, a wireless uplink transmitter circuit and a network data extraction circuit. According to further embodiments of the present invention, the wireless downlink receiver circuit may be adapted to receive a video based data signal. According to further embodiments of the present invention, the wireless uplink transmitter circuit may be adapted to transmit a control signal. According to further embodiments of the present invention, the network data extraction circuit may be adapted to extract network based data from a received transmission of the wireless downlink receiver circuit.

According to some embodiments of the present invention, the network data extraction circuit may be further adapted to forward network data to a functionally associated network device emulation circuit. According to further embodiments of the present invention, the network device emulation circuit may be further adapted to forward network data. According to further embodiments of the present invention, the network device emulation circuit may be further adapted to forward network data to a functionally associated data packet network port/output-line. According to further embodiments of the present invention, the data packet network port/output-line may be further adapted to forward network data to a functionally associated network data sink. According to further embodiments of the present invention, the data packet network port/output-line may be further adapted to be a wireless port.

According to some embodiments of the present invention, the wireless uplink transmitter may be further adapted to transmit network data to a functionally associated wireless video source transceiver. According to some embodiments of the present invention, the transceiver may be further adapted to receive network data from a functionally associated data network and transmit network data to another functionally associated data network.

According to some embodiments of the present invention there is provided a wireless video source transceiver comprising a wireless downlink transmitter circuit, a wireless uplink receiver circuit and a network data extraction circuit. According to further embodiments of the present invention, the wireless downlink transmitter circuit may be adapted to transmit a video based data signal. According to further embodiments of the present invention, the wireless uplink receiver circuit may be adapted to receive a control signal. According to further embodiments of the present invention, the network data extraction circuit may be adapted to extract network based data from a received transmission of the wireless uplink receiver circuit.

According to some embodiments of the present invention, the network data extraction circuit may be further adapted to forward network data to a functionally associated network device emulation circuit. According to further embodiments of the present invention, the network device emulation circuit may be further adapted to forward network data. According to further embodiments of the present invention, the network device emulation circuit may be further adapted to forward network data to a functionally associated data packet network port/output-line. According to further embodiments of the present invention, the data packet network port/output-line may be further adapted to forward network data to a functionally associated network data sink. According to further embodiments of the present invention, the data packet network port/output-line may be further adapted to be a wireless port.

According to some embodiments of the present invention, the wireless downlink transmitter may be further adapted to transmit network data to a functionally associated wireless video sink transceiver. According to some embodiments of the present invention, the transceiver may be further adapted to receive network data from a functionally associated data network and transmit network data to another functionally associated data network.

According to some embodiments of the present invention there is provided a wireless video sink transceiver comprising a wireless downlink receiver circuit, a wireless uplink transmitter circuit and a network data insertion circuit. According to further embodiments of the present invention, the wireless downlink receiver circuit may be adapted to receive a video based data signal. According to further embodiments of the present invention, the wireless uplink transmitter circuit may be adapted to transmit a control signal. According to further embodiments of the present invention, the network data insertion circuit may be adapted to receive network based data and to insert the data into a transmission of the wireless uplink transmitter circuit.

According to some embodiments of the present invention, the network data insertion circuit may be further adapted to receive network data from a functionally associated network device emulation circuit. According to further embodiments of the present invention, the network device emulation circuit may be further adapted to receive network data. According to further embodiments of the present invention, the network device emulation circuit may be further adapted to receive network data from a functionally associated data packet network port/input-line. According to further embodiments of the present invention, the data packet network port/input-line may be further adapted to receive network data from a functionally associated network data source. According to further embodiments of the present invention, the data packet network port/input-line may be further adapted to be a wireless port.

According to some embodiments of the present invention, the wireless downlink receiver may be further adapted to receive network data from a functionally associated wireless video source transceiver. According to some embodiments of the present invention, the transceiver may be further adapted to receive network data from a functionally associated data network and transmit network data to another functionally associated data network.

According to some embodiments of the present invention, there is provided a network data insertion circuit adapted to receive network data from a functionally associated network device emulation circuit and to insert the data into a transmission signal transmitted by a functionally associated wireless video signal transceiver.

According to some embodiments of the present invention, there is provided a network data extraction circuit adapted to extract network data from a signal received by a functionally associated wireless video signal transceiver and to forward the data to a functionally associated network device emulation circuit.

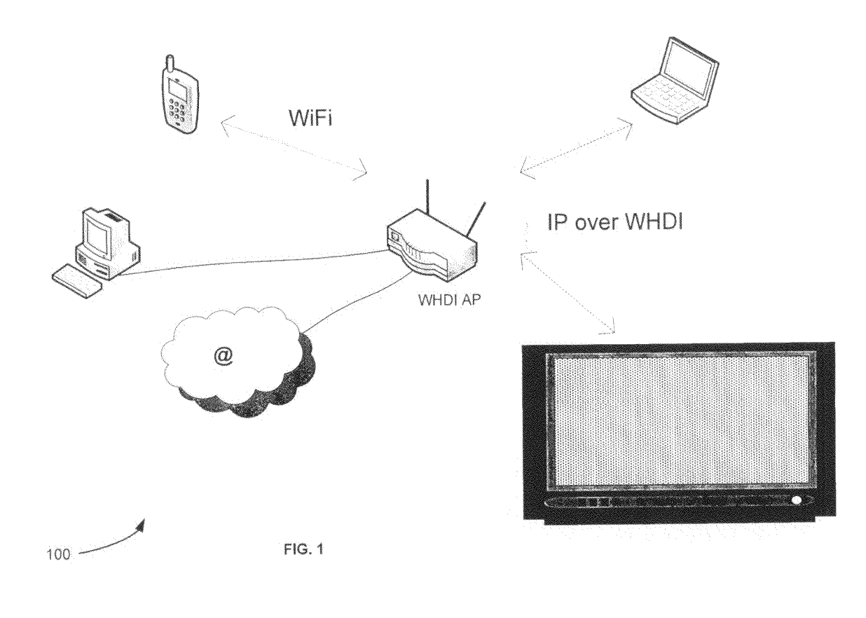

Now turning to FIG. 1, there is shown an exemplary video transceiver and data network arrangement (100), according to some embodiments of the present invention.

According to some embodiments of the present invention, a combined video transceiver and data network may include devices and/or systems communicating via various wired (e.g. Ethernet, Internet) and wireless (e.g. WIFI, WHDI) networks. According to further embodiments of the present invention, a network device emulation circuit or system may be adapted to emulate a network switch, router, bridge, access point, WHDI access point or any other network device or appliance capable of TCP/IP, UDP/IP or other data networking standard compliant communication. According to further embodiments of the present invention, the network device emulation circuit (e.g. a WHDI access point) may be adapted to receive video and/or network data from a device and/or system within the combined video transceiver and data network and transmit video and/or network data to the same or a different device and/or system within the combined video transceiver and data network.

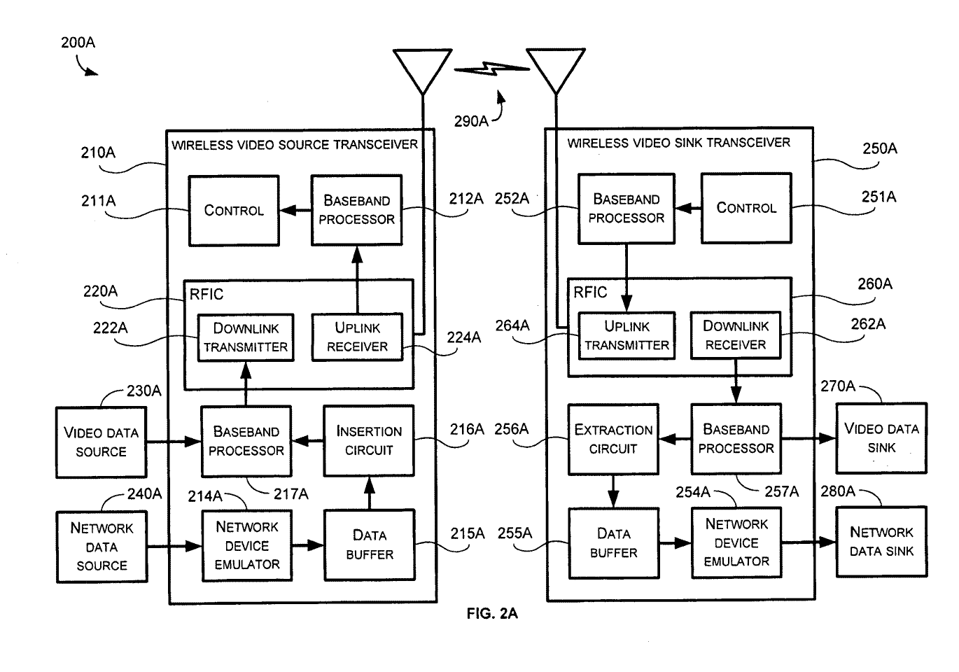

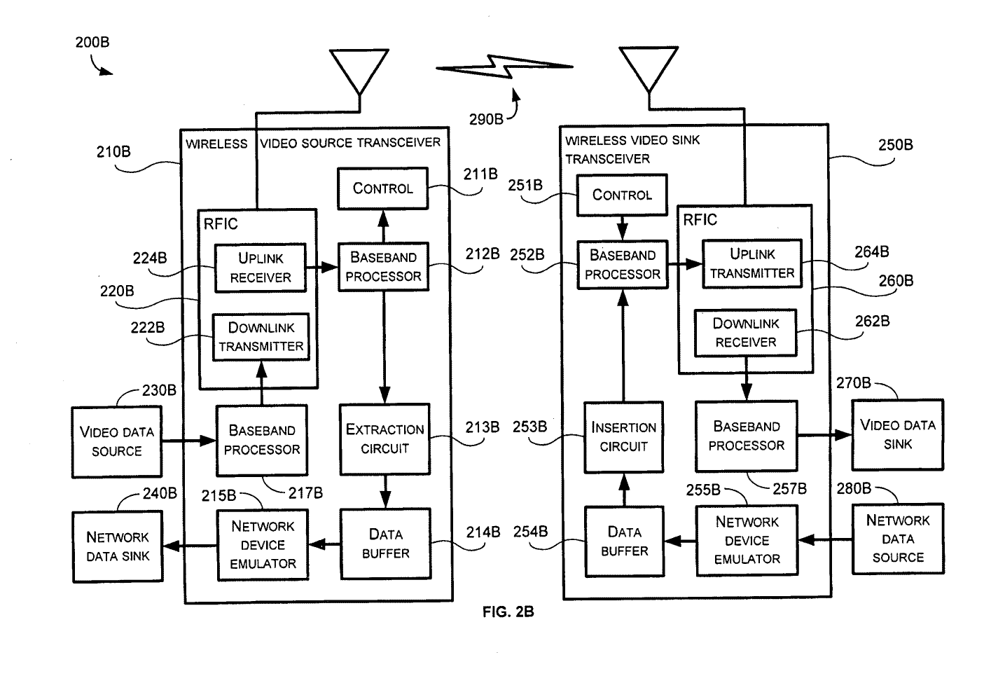

Now turning to FIG. 2A, there is shown a functional block diagram of an exemplary data transmitter/receiver pair (200A) according to some embodiments of the present invention where the transmitter includes an insertion circuit and the receiver includes an extraction circuit. According to further embodiments of the present invention, the transmitter/receiver pair (200A) may communicate via radio-frequency data signals (290A).

According to some embodiments of the present invention, a wireless video source transceiver (210A) may include a radio-frequency integrated chip (RFIC) (220A) to transmit and receive data signals along a functionally associated antenna. According to further embodiments of the present invention, the RFIC may include a downlink transmitter (222A) for transmitting downlink data signals and an uplink receiver (224A) for receiving uplink data signals.

According to some embodiments of the present invention, the wireless video source transceiver (210A) may include a baseband processor (212A) to process control signals received via the uplink receiver (224A) and send the data to a functionally associated control circuit and/or processor (211A). According to some embodiments of the present invention, the wireless video source transceiver (210A) may include a baseband processor (217A) to take incoming video data signals from a functionally associated video data source (230A) and process the data for downlink transmission, via the downlink transmitter (222A), to a functionally associated wireless video sink transceiver (250A).

According to some embodiments of the present invention, the wireless video source transceiver (210A) may include a network device emulator (214A) to take incoming network data signals from a functionally associated network data source (240A) and process the network data for storage in a data buffer (215A). According to further embodiments of the present invention, the wireless video source transceiver (210A) may include an insertion circuit (216A) to retrieve network data from the data buffer (215A) and forward the data to the baseband processor (217A) for insertion into a downlink transmission stream.

According to some embodiments of the present invention, a wireless video sink transceiver (250A) may include a RFIC chip (260A) to transmit and receive data signals along a functionally associated antenna. According to further embodiments of the present invention, the RFIC may include a downlink receiver (262A) for receiving downlink data signals and an uplink transmitter (264A) for transmitting uplink data signals.

According to some embodiments of the present invention, the wireless video sink transceiver (250A) may include a baseband processor (252A) to process control data received from a functionally associated control circuit and/or processor (251A) and send the control data to the uplink transmitter (264A). According to some embodiments of the present invention, the wireless video sink transceiver (250A) may include a baseband processor (257A) to take video data signals received, via the downlink receiver (262A), from a functionally associated wireless video source transceiver (210A) and process the data for a functionally associated video data sink (270A).

According to some embodiments of the present invention, the wireless video sink transceiver (250A) may include an extraction circuit (256A) to extract network data from the data signals processed by the baseband processor (257A) and store the data in a data buffer (255A). According to further embodiments of the present invention, the wireless video sink transceiver (250A) may include a network device emulator (254A) to retrieve network data from the data buffer (255A) and forward the data to a functionally associated network data sink (280A).

Now turning to FIG. 2B, there is shown a functional block diagram of an exemplary data transmitter/receiver pair according to some embodiments of the present invention where the receiver includes an insertion circuit and the transmitter includes an extraction circuit. According to further embodiments of the present invention, the transmitter/receiver pair (200B) may communicate via radio-frequency data signals (290B).

According to some embodiments of the present invention, a wireless video source transceiver (210B) may include a radio-frequency integrated chip (RFIC) (220B) to transmit and receive data signals along a functionally associated antenna. According to further embodiments of the present invention, the RFIC may include a downlink transmitter (222B) for transmitting downlink data signals and an uplink receiver (224B) for receiving uplink data signals.

According to some embodiments of the present invention, the wireless video source transceiver (210B) may include a baseband processor (212B) to process control signals received via the uplink receiver (224B) and send the data to a functionally associated control circuit and/or processor (211B). According to some embodiments of the present invention, the wireless video source transceiver (210B) may include a baseband processor (217B) to take incoming video data signals from a functionally associated video data source (230B) and process the data for downlink transmission, via the downlink transmitter (222B), to a functionally associated wireless video sink transceiver (250B).

According to some embodiments of the present invention, the wireless video source transceiver (210B) may include an extraction circuit (213B) to extract network data from the data signals processed by the baseband processor (212B) and store the data in a data buffer (214B). According to further embodiments of the present invention, the wireless video source transceiver (210B) may include a network device emulator (215B) to retrieve network data from the data buffer (214B) and forward the data to a functionally associated network data sink (240B).

According to some embodiments of the present invention, a wireless video sink transceiver (250B) may include a RFIC chip (260B) to transmit and receive data signals along a functionally associated antenna. According to further embodiments of the present invention, the RFIC may include a downlink receiver (262B) for receiving downlink data signals and an uplink transmitter (264B) for transmitting uplink data signals.

According to some embodiments of the present invention, the wireless video sink transceiver (250B) may include a baseband processor (252B) to process control data received from a functionally associated control circuit and/or processor (251B) and send the control data to the uplink transmitter (264B). According to some embodiments of the present invention, the wireless video sink transceiver (250B) may include a baseband processor (257B) to take video data signals received, via the downlink receiver (262B), from a functionally associated wireless video source transceiver (210B) and process the data for a functionally associated video data sink (270B).

According to some embodiments of the present invention, the wireless video sink transceiver (250B) may include a network device emulator (255B) to take incoming network data signals from a functionally associated network data source (280B) and process the network data for storage in a data buffer (254B). According to further embodiments of the present invention, the wireless video sink transceiver (250B) may include an insertion circuit (253B) to retrieve network data from the data buffer (254B) and forward the data to the baseband processor (252B) for insertion into an uplink transmission stream.

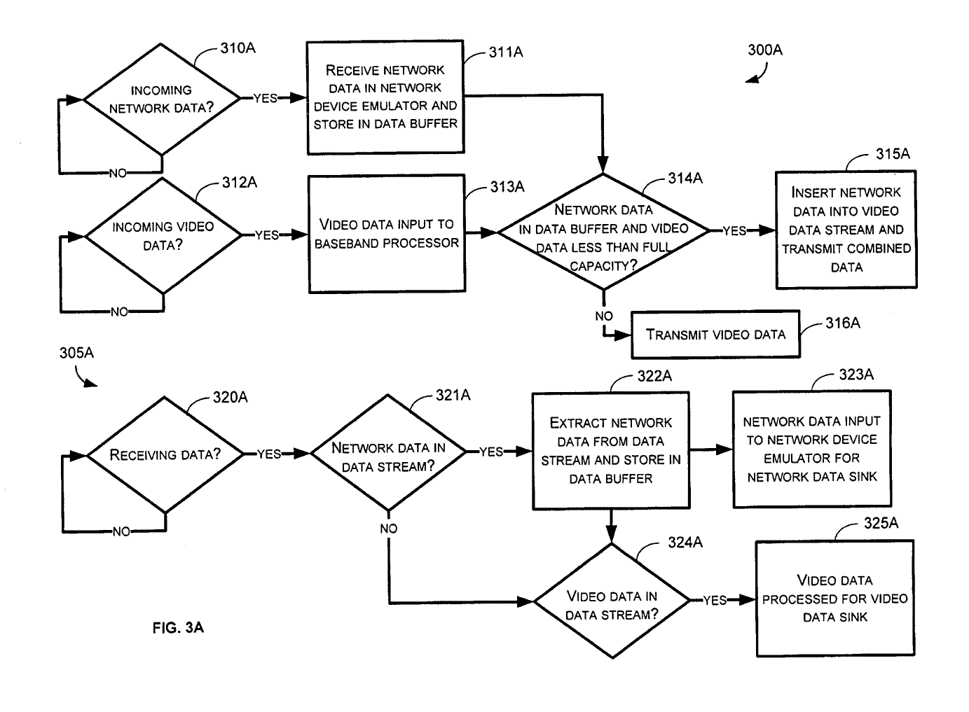

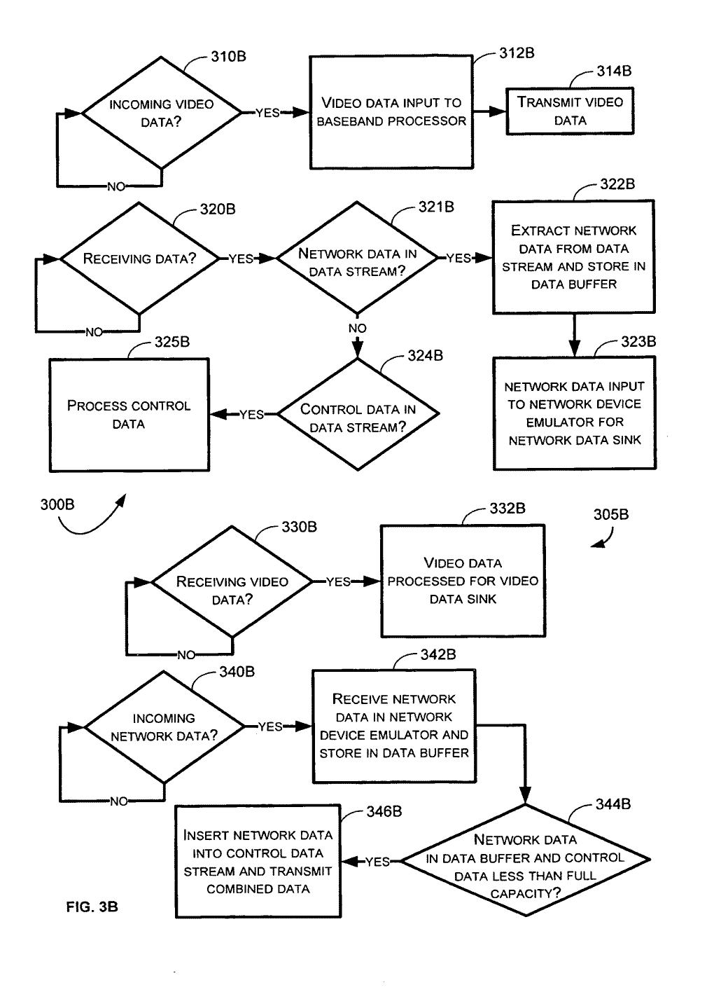

Now turning to FIG. 3A, there is shown a flow chart including the steps of a method by which a data transmitter/receiver pair may insert network data into a video data stream (300A) and extract network from a video data stream (305A) in accordance with the exemplary embodiment of FIG. 2A.

According to some embodiments of the present invention, a wireless video source transceiver (210A) may include a network device emulator (214A) to receive (311A) incoming network data from a functionally associated network data source (240A) and store the data in a data buffer (215A). According to further embodiments of the present invention, a video data source (230A) may input (313A) video data to a baseband processor (217A). According to further embodiments of the present invention, the wireless video source transceiver (210A) may transmit (316A) the video data. According to further embodiments of the present invention, the wireless video source transceiver (210A) may determine (314A) that network data is in the data buffer (215A) and that video data input is less than the full capacity for downlink transmission. According to further embodiments of the present invention, an insertion circuit (216A) may insert (315A) network data into the video data stream for the baseband processor (217A) to process the combined data for transmission.

According to some embodiments of the present invention, a wireless video sink transceiver (250A) may include a baseband processor (257A) to receive (320A) data. According to further embodiments of the present invention, the wireless video sink transceiver (250A) may determine (321A) that there is network data in the received data stream. According to further embodiments of the present invention, an extraction circuit (256A) may extract (322A) network data from the data stream and store the data in a data buffer (255A). According to further embodiments of the present invention, the network data may be input (323A) to a network device emulator (254A) for a network data sink (280A).

According to some embodiments of the present invention, the wireless video sink transceiver (250A) may determine (324A) that there is video data in the received data stream. According to further embodiments of the present invention, the video data may be processed (325A) for a video data sink (270A).

Now turning to FIG. 3B, there is shown a flow chart including the steps of a method by which a data transmitter/receiver pair may extract network from a video data stream (300B) and insert network data into a video data stream (305B) in accordance with the exemplary embodiment of FIG. 2B.

According to some embodiments of the present invention, a wireless video source transceiver (210B) may determine (310B) that there is incoming video data from a video data source (230B). According to further embodiments of the present invention, the video data source (230B) may input (312B) the video data to a baseband processor (217B). According to further embodiments of the present invention, the wireless video source transceiver (210B) may transmit (314B) the video data.

According to some embodiments of the present invention, the wireless video source transceiver (210B) may include a baseband processor (2212B) to receive (320B) data. According to further embodiments of the present invention, the wireless video source transceiver (210B) may determine (321B) that there is network data in the received data stream. According to further embodiments of the present invention, an extraction circuit (213B) may extract (322B) network data from the data stream and store the data in a data buffer (214B). According to further embodiments of the present invention, the network data may be input (323B) to a network device emulator (215B) for a network data sink (240B).

According to some embodiments of the present invention, the wireless video source transceiver (210B) may determine (324B) that there is control data in the received data stream. According to further embodiments of the present invention, the control data may be processed (325B) for a control circuit or device (211B).

According to some embodiments of the present invention, a wireless video sink transceiver (250B) may receive (330B) an incoming video data stream. According to further embodiments of the present invention, the video data may be processed (332B) for a video data sink (270B).

According to some embodiments of the present invention, the wireless video sink transceiver (250B) may include a network device emulator (255B) to receive (342B) incoming network data from a functionally associated network data source (280B) and store the data in a data buffer (254B). According further embodiments of the present invention, a control circuit or device (251B) may input control data to a baseband processor (252B). According to further embodiments of the present invention, the wireless video sink transceiver (250B) may transmit the video data. According to further embodiments of the present invention, the wireless video sink transceiver (250B) may determine (344B) that network data is in the data buffer (254B) and that control data input is less than the full capacity for uplink transmission. According to further embodiments of the present invention, an insertion circuit (253B) may insert (346B) network data into the control data stream for the baseband processor (252A) to process the combined data for transmission.

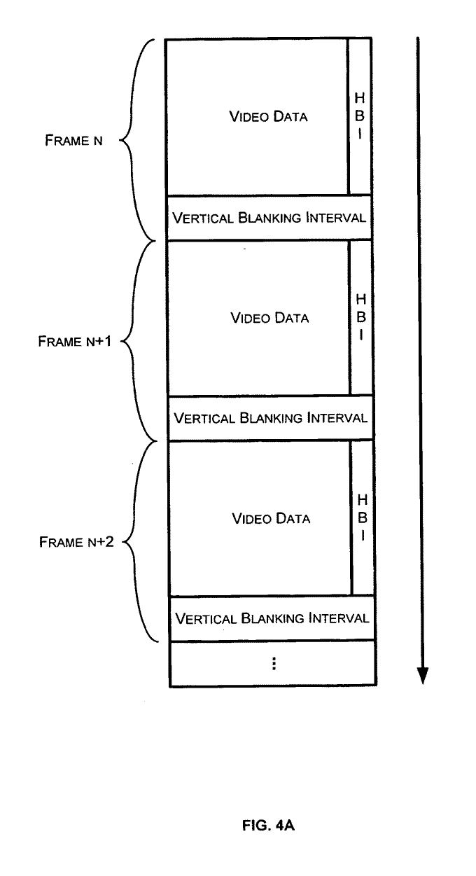

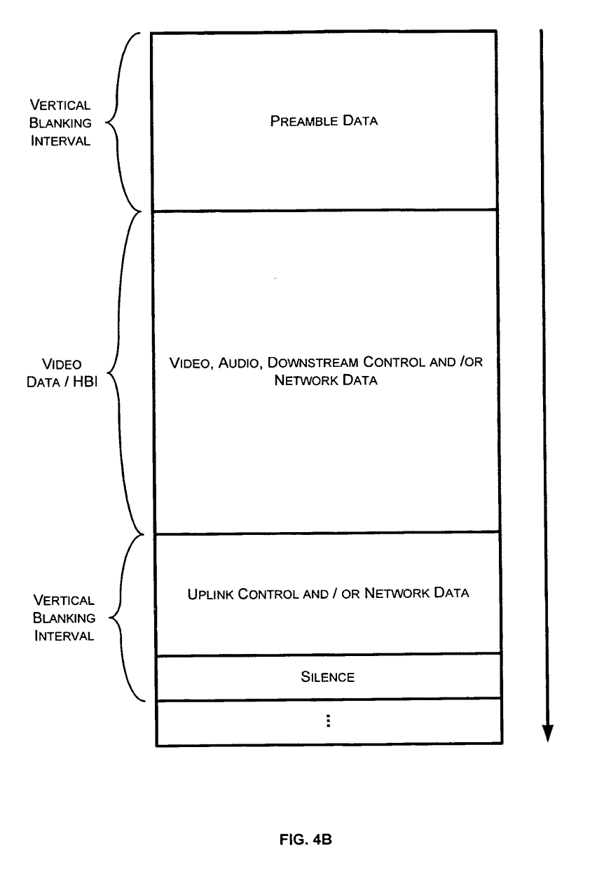

Now turning to FIG. 4A, there is shown a schematic diagram of video frames in which each frame has a video data portion, a horizontal blanking interval (HBI) portion and a vertical blanking interval (VBI) portion (prior art).

Now turning to FIG. 4B, there is shown a schematic diagram showing a video frame according to some embodiments of the present invention.

According to some embodiments of the present invention, an initial time slot reserved for a VBI in the prior art may be used to transmit preamble data (e.g. set-up or protocol information). According to further embodiments of the present invention, the video data portion and HBI portion in the prior art may be combined to form a downlink transmission and reception slot. According to further embodiments of the present invention, the downlink transmission and reception slot may include video data, audio data, control data, and/or network data. According to further embodiments of the present invention, the VBI portion in the prior art may be used for transmitting and receiving uplink control and/or network data. According to further embodiments of the present invention, a time slot may be reserved for uplink and downlink silence (i.e. a guard interval).

Some embodiments of the invention, for example, may take the form of an entirely hardware embodiment, an entirely software embodiment, or an embodiment including both hardware and software elements. Some embodiments may be implemented in software, which includes but is not limited to firmware, resident software, microcode, or the like.

Furthermore, some embodiments of the invention may take the form of a computer program product accessible from a computer- usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system, apparatus, or device.

In some embodiments, the medium may be an electronic, magnetic, optical, electromagnetic, infrared, or semiconductor system (or apparatus or device) or a propagation medium. Some demonstrative examples of a computer-readable medium may include a semiconductor or solid state memory, magnetic tape, a removable computer diskette, a random access memory (RAM), a read-only memory (ROM), a rigid magnetic disk, and an optical disk. Some demonstrative examples of optical disks include compact disk—read only memory (CD-ROM), compact disk—read/write (CD-R/W), and DVD.

In some embodiments, a data processing system suitable for storing and/or executing program code may include at least one processor coupled directly or indirectly to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution.

In some embodiments, input/output or I/O devices (including but not limited to keyboards, displays, pointing devices, etc.) may be coupled to the system either directly or through intervening I/O controllers. In some embodiments, network adapters may be coupled to the system to enable the data processing system to become coupled to other data processing systems or remote printers or storage devices, for example, through intervening private or public networks. In some embodiments, modems, cable modems and Ethernet cards are demonstrative examples of types of network adapters. Other suitable components may be used.

Functions, operations, components and/or features described herein with reference to one or more embodiments, may be combined with, or may be utilized in combination with, one or more other functions, operations, components and/or features described herein with reference to one or more other embodiments, or vice versa.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A wireless video source transceiver comprising:
a wireless downlink transmitter circuit adapted to transmit a video based data signal;
a wireless uplink receiver circuit adapted to receive a control signal; and
a network data insertion circuit adapted to receive network based data and to insert the data into a transmission of said wireless downlink transmitter circuit.

2. The transceiver according to claim 1, wherein said network data insertion circuit is further adapted to receive network data from a functionally associated network device emulation circuit.

3. The transceiver according to claim 2, wherein said network device emulation circuit is further adapted to receive network data.

4. The transceiver according to claim 3, wherein said network device emulation circuit is further adapted to receive network data from a functionally associated data packet network port/input-line.

5. The transceiver according to claim 4, wherein said data packet network port/input-line is further adapted to receive network data from a functionally associated network data source.

6. The transceiver according to claim 5, wherein said data packet network port/input-line is further adapted to be a wireless port.

7. The transceiver according to claim 1, wherein said wireless uplink receiver is further adapted to receive network data from a functionally associated wireless video sink transceiver.

8. The transceiver according to claim 1, further adapted to receive network data from a functionally associated data network and transmit network data to another functionally associated data network.

9. A wireless video sink transceiver comprising:
a wireless downlink receiver circuit adapted to receive a video based data signal;
a wireless uplink transmitter circuit adapted to transmit a control signal; and
a network data extraction circuit adapted to extract network based data from a received transmission of said wireless downlink receiver circuit.

10. The transceiver according to claim 9, wherein said network data extraction circuit is further adapted to forward network data to a functionally associated network device emulation circuit.

11. The transceiver according to claim 10, wherein said network device emulation circuit is further adapted to forward network data.

12. The transceiver according to claim 11, wherein said network device emulation circuit is further adapted to forward network data to a functionally associated data packet network port/output-line.

13. The transceiver according to claim 12, wherein said data packet network port/output-line is further adapted to forward network data to a functionally associated network data sink.

14. The transceiver according to claim 13, wherein said data packet network port/output-line is further adapted to be a wireless port.

15. The transceiver according to claim 9, wherein said wireless uplink transmitter is further adapted to transmit network data a functionally associated wireless video source transceiver.

16. The transceiver according to claim 9, further adapted to receive network data from a functionally associated data network and transmit network data to another functionally associated data network.

17. A wireless video source transceiver comprising:
a wireless downlink transmitter circuit adapted to transmit a video based data signal;
a wireless uplink receiver circuit adapted to receive a control signal; and
a network data extraction circuit adapted to extract network based data from a received transmission of said wireless uplink receiver circuit.

18. The transceiver according to claim 17, wherein said network data extraction circuit is further adapted to forward network data to a functionally associated network device emulation circuit.

19. The transceiver according to claim 18, wherein said network device emulation circuit is further adapted to forward network data.

20. The transceiver according to claim 19, wherein said network device emulation circuit is further adapted to forward network data to a functionally associated data packet network port/output-line.

21. The transceiver according to claim 20, wherein said data packet network port/output-line is further adapted to forward network data to a functionally associated network data sink.

22. The transceiver according to claim 21, wherein said data packet network port/output-line is further adapted to be a wireless port.

23. The transceiver according to claim 17, wherein said wireless downlink transmitter is further adapted to transmit network data to a functionally associated wireless video sink transceiver.

24. The transceiver according to claim 17, further adapted to receive network data from a functionally associated data network and transmit network data to another functionally associated data network.

25. A wireless video sink transceiver comprising:
a wireless downlink receiver circuit adapted to receive a video based data signal;
a wireless uplink transmitter circuit adapted to transmit a control signal; and
a network data insertion circuit adapted to receive network based data and to insert the data into a transmission of said wireless uplink transmitter circuit.

26. The transceiver according to claim 25, wherein said network data insertion circuit is further adapted to receive network data from a functionally associated network device emulation circuit.

27. The transceiver according to claim 26, wherein said network device emulation circuit is further adapted to receive network data.

28. The transceiver according to claim 27, wherein said network device emulation circuit is further adapted to receive network data from a functionally associated data packet network port/input-line.

29. The transceiver according to claim 28, wherein said data packet network port/input-line is further adapted to receive network data from a functionally associated network data source.

30. The transceiver according to claim 29, wherein said data packet network port/input-line is further adapted to be a wireless port.

31. The transceiver according to claim 25, wherein said wireless downlink receiver is further adapted to receive network data from a functionally associated wireless video source transceiver.

32. The transceiver according to claim 25, further adapted to receive network data from a functionally associated data network and transmit network data to another functionally associated data network.

33. A network data insertion circuit adapted to receive network data from a functionally associated network device emulation circuit and to insert the data into a transmission signal transmitted by a functionally associated wireless video signal transceiver.

34. A network data extraction circuit adapted to extract network data from a signal received by a functionally associated wireless video signal transceiver and to forward the data to a functionally associated network device emulation circuit.
